(19) United States
(12) Patent Application Publication
(10) Pub. No.: US 2025/0136063 A1
(43) Pub. Date: May 1, 2025

(54) SYSTEMS AND METHODS FOR IN-CARWASH VEHICLE SERVICES

(71) Applicant: Ford Global Technologies, LLC, Dearborn, MI (US)

(72) Inventors: Robert Schroeter, Livonia, MI (US); Mahmoud Yousef Ghannam, Canton, MI (US); Jake Schwartz, Dearborn, MI (US)

(73) Assignee: Ford Global Technologies, LLC, Dearborn, MI (US)

(21) Appl. No.: 18/499,839

(22) Filed: Nov. 1, 2023

(51) Int. Cl. B60S 3/04; B60S 3/00

(52) U.S. Cl. CPC B60S 3/04; B60S 3/004

(57) ABSTRACT

A vehicle including a detection unit and a processor is disclosed. The detection unit may be configured to capture images outside the vehicle. The processor may obtain inputs from the detection unit, and determine that the vehicle may be within a predefined distance of a car wash entry point associated with a car wash station. The processor may determine a first action to be performed when the vehicle is within the predefined distance. The first action includes one or more steps. The processor may be configured to output a first notification to perform a first step, determine that the first step is completed, and output a second notification to perform a second step responsive to a determination that the first step is completed. The processor is further configured to determine that the second step is completed, and output a third notification when the first and second steps are completed.

### FIELD

The present disclosure relates to a vehicle and more particularly to systems and methods for in-carwash vehicle services.

### BACKGROUND

People often use car wash/auto wash services to quickly clean exterior surfaces of their vehicles. Some car wash stations have a track that pulls the vehicle along the track, and then the vehicle is automatically washed by using pressurized water supply system, cleaning agents, and/or the like.

A vehicle user may perform certain operations when the vehicle enters a car wash station. For example, the vehicle user may deactivate automatic vehicle wipers and/or fold side view mirrors when the vehicle enters the car wash station. Further, the vehicle user may activate a vehicle neutral mode when the vehicle may be aligned with or disposed on the track. Such operations may be cumbersome for the vehicle user to perform.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an environment in which techniques and structures for providing the systems and methods disclosed herein may be implemented.

FIG. 2 depicts a block diagram of a system for controlling operation of a vehicle in a car wash station in accordance with the present disclosure.

FIG. 3 depicts a workflow for controlling a vehicle operation in accordance with the present disclosure.

FIG. 4 depicts a snapshot of a notification output by a vehicle in accordance with the present disclosure.

FIG. 5 depicts a flow diagram of a method for controlling operation of a vehicle in a car wash station in accordance with the present disclosure.

### DETAILED DESCRIPTION

### Overview

The present disclosure describes a vehicle management unit (“unit”) that may be configured to automatically control vehicle operations and/or assist a vehicle user in performing operations associated with a vehicle when the vehicle may be approaching/located at car wash station. The unit may assist the vehicle user in conveniently getting the vehicle cleaned at the car wash station. In some aspects, the unit may be configured to obtain inputs from a vehicle detection unit and detect that the vehicle may be approaching the car wash station based on the obtained inputs. Responsive to a determination that the vehicle may be approaching the car wash station, the unit may be configured to automatically perform one or more actions, e.g., disabling wipers temporarily, closing side view mirrors, closing vehicle windows, and/or the like. The unit may further output one or more notifications informing the vehicle user that the unit has automatically performed the actions.

In alternative aspects, instead of automatically performing the actions described above, the unit may output a notification to the vehicle user, requesting the vehicle user to manually perform the actions described above, when the unit determines that the vehicle may be approaching the car wash station. For example, the unit may request the vehicle user to manually disable the wiper system, close (e.g., retract) the side view mirrors, and/or position the vehicle in a neutral mode.

In further aspects, the unit may automatically align the vehicle with a track (or a conveyor system) associated with the car wash system when the unit determines that the vehicle may be located inside the car wash station. In some aspects, the unit may determine that the vehicle may be located inside the car wash station by estimating a distance between the vehicle and the track, based on the inputs obtained from the vehicle detection unit. When the estimated distance may be less than a predefined threshold, the unit may determine that the vehicle may be located in proximity to the track, and hence inside the car wash station. In an alternative aspect, instead of automatically aligning the vehicle with the track, the unit may output a notification to the vehicle user, requesting the vehicle user to manually align the vehicle with the track based on the inputs obtained from the vehicle detection unit.

The unit may further automatically position the vehicle in the neutral mode when the vehicle may be aligned with the track. In other aspects, the unit may output a notification to the vehicle user requesting the vehicle user to manually position the vehicle in the neutral mode when the unit determines that the vehicle may be aligned with the track.

In some aspects, the unit may determine an action (e.g., position the vehicle in the neutral mode) to be performed when the vehicle may be approaching the car wash station. The action of positioning the vehicle in the neutral mode may include one or more steps such as pressing and holding a vehicle speed reduction pedal, shifting the vehicle in neutral, pressing low button on a dial, releasing the vehicle speed reduction pedal, and/or turning-off the vehicle. Thus, in accordance with an embodiment, the unit may output a first notification requesting a vehicle operator to perform a first step (e.g., pressing and holding the vehicle speed reduction pedal) of the one or more steps when the vehicle may be approaching the car wash station. Responsive to outputting the first notification, the unit may determine that the first step may be completed (e.g., performed by the vehicle operator). The unit may then output a second notification requesting the vehicle operator to perform a second step (e.g., shifting the vehicle in neutral) of the one or more steps when the unit determines that the first step may be completed. The unit may further determine that the second step may be completed, and may then output a third notification requesting the vehicle operator to perform additional steps or indicating that the action may be completed by the vehicle operator. The unit may output the third notification based on a determination that the first step and the second step may be completed by the vehicle operator. Accordingly, where the action includes multiple steps, notifications may be generated and presented to the user indicating each step, one step at a time, and after the presentation of each notification a determination may be made as to whether the associated step was performed to satisfactory completion before a notification of the next step is generated and presented.

In further aspects, the unit may be configured to determine that the vehicle may be exiting the car wash station based on the inputs obtained from the vehicle detection unit. Responsive to a determination that the vehicle may be exiting the car wash station, the unit may perform one or more additional actions. For example, the unit may re-enable the wipers, unfold the side view mirrors, take the vehicle out of the neutral mode, and/or the like. Alternatively, the unit may output notifications requesting the vehicle operator to perform the steps described above.

The present disclosure discloses a vehicle car wash management unit that automatically detects that the vehicle may be approaching a car wash station and then controls vehicle operations (e.g., activate/deactivate vehicle components) to minimize user involvement during car wash transition times. The unit automatically determines when the vehicle should switch to neutral and performs actions accordingly. Similarly, the unit detects that the vehicle is exiting the car wash station and then controls the vehicle operations accordingly.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

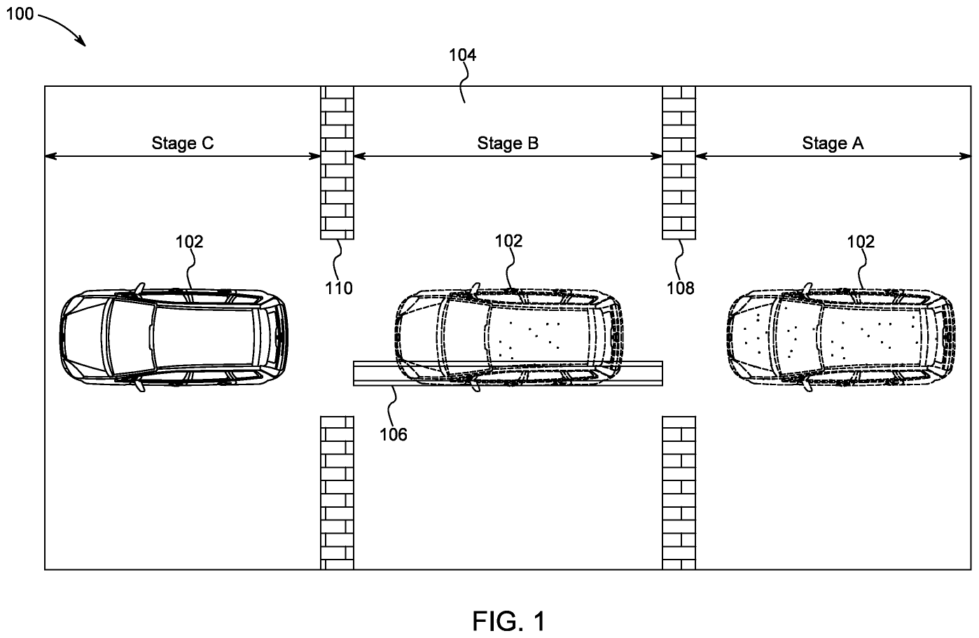

FIG. 1 depicts an example environment 100 in which techniques and structures for providing the systems and methods disclosed herein may be implemented. The environment 100 may include a vehicle 102 that may take the form of any passenger or commercial vehicle such as, for example, a car, a work vehicle, a crossover vehicle, a truck, a van, a minivan, a taxi, a bus, etc. The vehicle 102 may be a manually driven vehicle and/or may be configured to operate in a partially autonomous mode and may include any powertrain such as, for example, a gasoline engine, one or more electrically-actuated motor(s), a hybrid system, etc.

The environment 100 may further include a car wash station 104 (or car wash facility). The car wash station 104 may include a track 106 (e.g., a conveyor) that may automatically pull the vehicle 102 along when the vehicle 102 may be disposed on the track 106. In an exemplary aspect, the track 106 may pull the vehicle 102 through a plurality of areas or zones associated with the car wash station 104. The plurality of zones may be associated with a pressurized water supply zone, a cleaning agent zone, a rinse zone, a dry zone, and/or the like. As the vehicle 102 is pulled through the plurality of zones, soap/cleaning agents, pressurized water and brushes may be applied to the vehicle exterior surface to wash/clean the vehicle 102 (e.g., the vehicle exterior surface). When the vehicle 102 may be washed and rinsed, excess water may be dried by using an air dryer or any other known method.

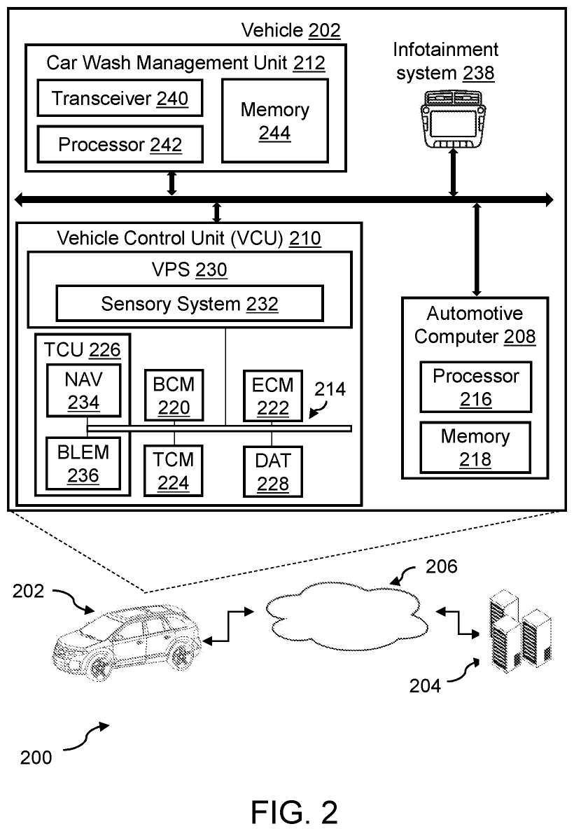

In some aspects, the vehicle 102 may include a car wash management unit or “unit” (shown as car wash management unit 212 in FIG. 2) that may assist a vehicle user in getting the vehicle 102 cleaned when the vehicle 102 may be disposed in or in proximity to the car wash station 104. In some aspects, the unit may be configured to control vehicle operations automatically when the vehicle 102 reaches the car wash station 104. In other aspects, the unit may output one or more notification(s) requesting the vehicle user to perform one or more actions (e.g., to control vehicle operations) when the vehicle 102 reaches the car wash station 104, and in some aspects, confirm a step is performed before requesting a next step to be performed. The unit may be configured to control vehicle operations in three stages (shown as Stage A, Stage B and Stage C in FIG. 1) associated with a vehicle movement in proximity to or in the car wash station 104.

Stage A may be a stage when the vehicle 102 approaches the car wash station 104. In some aspects, Stage A may be the stage in which the vehicle 102 may be disposed at a first predefined distance (e.g., 0 to 50 meters) away from a car wash entry point 108. Stage B may be a stage in which the vehicle 102 may be located inside the car wash station 104 (having the plurality of zones to clean and dry the vehicle 102, as described above). Stage C may be a stage in which the vehicle 102 may be outside car wash station 104 (e.g., when the vehicle 102 exits the car wash station 104 after getting cleaned/washed). In some aspects, Stage C may be the stage in which the vehicle 102 may be disposed at a second predefined distance (e.g., 0 to 50 meters) away from a car wash exit point 110.

During operation, the unit may obtain inputs from a vehicle detection unit at a predefined frequency. In some aspects, the vehicle detection unit may include vehicle exterior cameras (e.g., a first detection unit) that may be configured to capture images of a geographical area outside the vehicle 102. Responsive to obtaining the inputs from the vehicle detection unit, the unit may detect/determine that the vehicle 102 may be approaching the car wash station 104 (i.e., the vehicle 102 may be located at the predefined distance away from the car wash entry point 108) based on the inputs. The unit may then determine one or more actions to be performed when the unit determines that the vehicle 102 may be disposed within the predefined distance from the car wash station 104.

In some aspects, the actions may include automatically disabling vehicle wipers, folding vehicle side view mirrors, and/or the like. As an example, the unit may automatically disable vehicle wipers and/or fold side view mirrors when the unit determines that the vehicle 102 may be in the stage A. Stated another way, the unit disables the vehicle wipers and folds the side view mirrors before the vehicle 102 enters the car wash station 104. In additional aspects, the actions may include transmitting/outputting a notification, e.g., via a vehicle infotainment system or a user device associated with the vehicle user, indicating to the vehicle user that the automatic operation of vehicle wipers has been temporarily disabled and/or the side view mirrors are folded. In alternative aspects, the actions may include transmitting/outputting a notification, via the vehicle infotainment system or the user device, requesting the vehicle user to turn-off automatic operation of vehicle wipers and/or fold the side view mirrors.

In addition, the unit may determine a vehicle position relative to the track 106 and determine that the vehicle 102 may have entered the car wash station 104 or crossed the car wash entry point 108 (e.g., be at the stage B) based on the determined vehicle position. In some aspects, the unit may determine the vehicle position based on the inputs obtained from the vehicle detection unit. In an exemplary aspect, the vehicle detection unit may include, along with the first detection unit (vehicle exterior cameras described above) described above, a second detection unit that may include sensors such as radio detecting and ranging (radar) sensors, light detection and ranging (lidar) sensors, and/or the like. The unit may estimate a distance between the vehicle 102 and the track 106 (and hence the vehicle position relative to the track 106) based on the inputs obtained from the vehicle exterior cameras (i.e., the first detection unit) and radar, lidar sensors (i.e., the second detection unit).

Responsive to determining the vehicle position relative to the track 106, the unit may perform an action, of the one or more actions described above, based on the estimated distance. For example, the unit may automatically align the vehicle 102 (e.g., move and align a vehicle wheel) with the track 106 when the vehicle 102 enters stage B and is disposed in proximity to the track 106. Alternatively, the unit may output notifications/instructions to the vehicle user (e.g., via the vehicle infotainment system or the user device) requesting the vehicle user to align the vehicle 102 with the track 106 and position the vehicle 102 on the track 106.

Responsive to automatically aligning the vehicle 102 with the track 106 or responsive to the vehicle user aligning the vehicle 102, the unit may determine that the vehicle 102 may be properly aligned with the track 106 (and positioned on the track 106) based on the inputs obtained from the first detection unit and/or the second detection unit. Responsive to a determination that the vehicle 102 may be properly aligned/positioned, the unit may perform yet another action. For example, the unit may automatically position the vehicle 102 in a neutral mode and output/transmit a notification (e.g., via the vehicle infotainment system or the user device) to the vehicle user indicating that the vehicle 102 is positioned in the neutral mode. Alternatively, the unit may transmit an instruction/notification to the vehicle user requesting the vehicle user to position the vehicle 102 in the neutral mode when the vehicle 102 may be aligned on the track 106.

Similarly, the unit may perform another action when the vehicle 102 exits the car wash station 104 (i.e., when the vehicle 102 is in stage C). For example, the unit may re-enable the vehicle wipers, take the vehicle 102 out of the neutral mode, and unfold the side view mirrors, in the manner as described above (e.g., automatically or by transmitting instructions for the vehicle user), when the vehicle 102 exits the car wash station 104.

Further details of the vehicle 102 and the unit are described below in conjunction with FIG. 2.

Although the description above describes an aspect where the vehicle 102 drives through the car wash station 104, however, the present disclosure is not limited to such an aspect. In other aspects of the present disclosure, the vehicle 102 may be pulled inside the car wash station 104 through the car wash entry point 108, and may come back through the same car wash entry point 108. Stated another way, the car wash entry point 108 may be same as the car wash exit point 110.

In addition, although the description above describes an aspect where the car wash station 104 includes the track 106 and the plurality of zones, however, the present disclosure is not limited to such an aspect. In another aspect, the car wash station 104 may not have the track 106 and/or the plurality of zones.

In further aspects, the car wash station 104 may include a robotic arm that may move around the vehicle 102 to clean the vehicle 102 (and the vehicle 102 may not be required to move during the cleaning operation). In such cases, the unit may align the vehicle 102 at a desired position (e.g., by using the vehicle detection unit) and may perform the actions as described above. As an example, the unit may automatically disable vehicle wipers and/or fold side view mirrors when the unit determines that the vehicle 102 may be approaching the car wash station 104.

The vehicle 102, the unit and/or the vehicle user implement and/or perform operations, as described here in the present disclosure, in accordance with the owner manual and safety guidelines. In addition, any action taken by the vehicle user based on recommendations or notifications provided by the vehicle 102 and/or the unit should comply with all the rules specific to the location and operation of the vehicle 102 (e.g., Federal, state, country, city, etc.). The recommendation or notifications, as provided by the vehicle 102 and/or the unit should be treated as suggestions and only followed according to any rules specific to the location and operation of the vehicle 102.

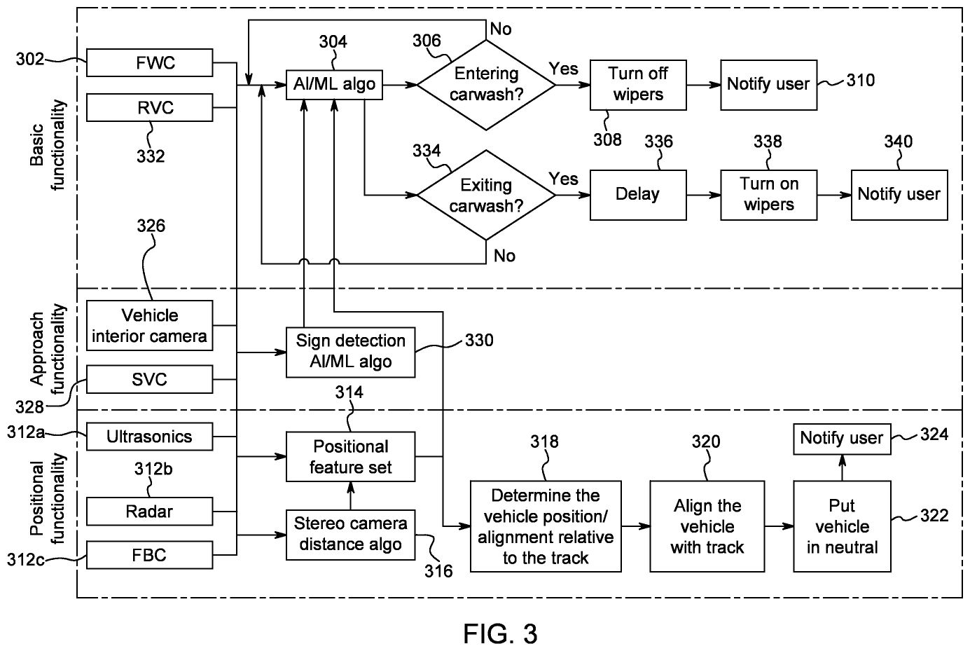

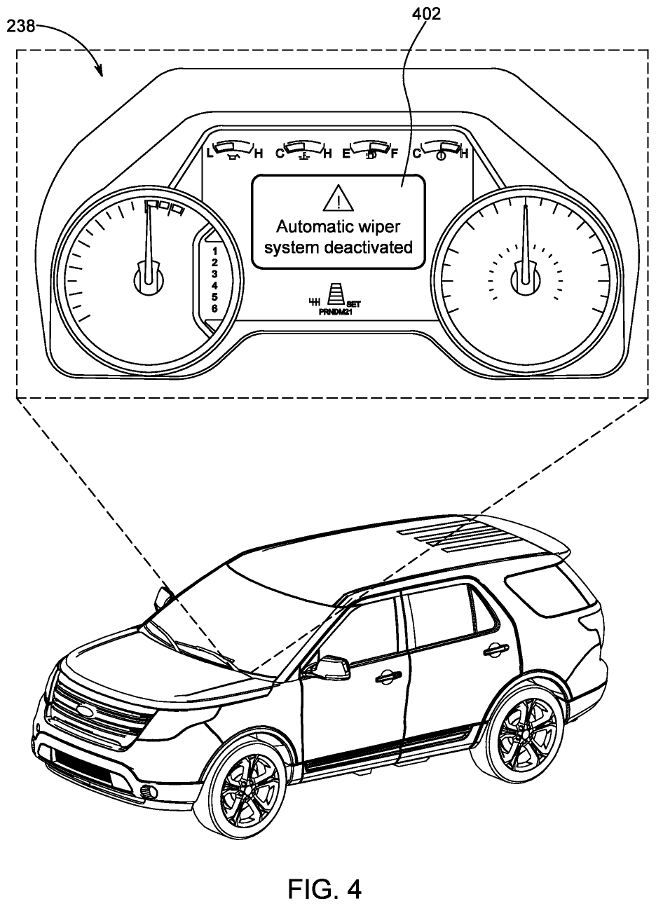

FIG. 2 depicts a block diagram of an example system 200 for controlling operation of a vehicle 202 in the car wash station 104 in accordance with the present disclosure. While describing FIG. 2, references will be made to FIGS. 3 and 4.

The system 200 may include a vehicle 202 that may be same as the vehicle 102 described above in conjunction with FIG. 1. The system 200 may further include a server 204 that may be communicatively coupled with the vehicle 202 via one or more networks 206. In some aspects, the server 204 may be associated with a firm/operator operating the car wash station 104 described above in conjunction with FIG. 1. The server 204 may store information associated with a car wash station map or architecture, for example, location of the track 106, the car wash entry point 108, the car wash exit point 110, and/or the like. The server 204 may transmit, via the network(s) 206, the information associated with a car wash station map or architecture to the vehicle 202 at a predefined frequency or when the vehicle 202 transmits a request to the server 204 for obtaining the information.

The network 206 illustrates an example communication infrastructure in which the connected devices discussed in various embodiments of this disclosure may communicate. The network 206 may be and/or include the Internet, a private network, public network or other configuration that operates using any one or more known communication protocols such as, for example, transmission control protocol/Internet protocol (TCP/IP), Bluetooth®, BLE, Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 202 may include a plurality of units including, but not limited to, an automotive computer 208, a Vehicle Control Unit (VCU) 210, and a car wash management unit 212. The VCU 210 may include a plurality of Electronic Control Units (ECUs) 214 disposed in communication with the automotive computer 208.

The automotive computer 208 may be installed anywhere in the vehicle 202. The automotive computer 208 may be or include an electronic vehicle controller, having one or more processor(s) 216 and a memory 218.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing aspects in accordance with the disclosure. The memory 218 may be a non-transitory computer-readable medium or memory storing a car wash management program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle systems, connected servers, and other vehicles (not shown) operating as part of a vehicle fleet. The VCU 210 may include or communicate with any combination of the ECUs 214, such as, for example, a Body Control Module (BCM) 220, an Engine Control Module (ECM) 222, a Transmission Control Module (TCM) 224, a telematics control unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (“lidar”) sensor, door sensors, proximity sensors, wheel sensors, ambient weather sensors, vehicle interior and exterior cameras, steering wheel sensors, etc.

In some aspects, the vehicle sensory system 232 may include the first detection unit and the second detection unit described above in conjunction with FIG. 1. The first detection unit may include vehicle exterior cameras (e.g., vehicle forward-windshield camera, vehicle rear view camera, vehicle side view camera, vehicle 360 degree cameras, etc.), which may be configured to capture images of a geographical area outside the vehicle 202 (and/or detect the vehicle position relative to the track 106). The second detection unit may include one or more of a radar sensor, a lidar sensor, ultrasonic sensors, and/or other proximity sensors configured to detect the vehicle position relative to the track 106.

In some aspects, the VCU 210 may control vehicle operational aspects and implement one or more instruction sets stored in the memory 218 and/or the instructions received from the car wash management unit 212.

The TCU 226 may be configured and/or programmed to provide vehicle connectivity to wireless computing systems onboard and off board the vehicle 202 and may include a Navigation (NAV) receiver 234 for receiving and processing a GPS signal, a BLE® Module (BLEM) 236 or BUN (BLE, UWB, NFC module), a Wi-Fi transceiver, a Ultra-Wideband (UWB) transceiver, Low-frequency antennas, remote tuner module (RTM) antennas, and/or other wireless transceivers/antennas (not shown in FIG. 2) that may be configurable for wireless communication (including cellular communication) between the vehicle 202 and other systems (e.g., the server 204), computers, and modules. The TCU 226 may be disposed in communication with the ECUs 214 by way of a bus.

The ECUs 214 may control aspects of vehicle operation and communication using inputs from human drivers, inputs from an autonomous vehicle controller and/or DAT controller 228, and/or via wireless signal inputs received via the wireless connection(s) from other connected devices, such as user devices, servers (including the server 204), among others.

The BCM 220 generally includes integration of sensors, vehicle performance indicators, and variable reactors associated with vehicle systems and may include processor-based power distribution circuitry that may control functions associated with the vehicle body such as lights, windows, security, camera(s), audio system(s), speakers, wipers, mirrors (e.g., side view mirrors), vehicle gear system, door locks and access control, and various comfort controls. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some aspects, the automotive computer 208 may connect with an infotainment system 238. The infotainment system 238 may include a touchscreen interface portion and may include voice recognition features, biometric identification capabilities that can identify users based on facial recognition, voice recognition, fingerprint identification, or other biological identification means. In other aspects, the infotainment system 238 may be further configured to receive user instructions via the touchscreen interface portion and/or display notifications (including visual alert notifications), navigation maps, etc. on the touchscreen interface portion.

The computing system architecture of the automotive computer 208 and the VCU 210 may omit certain computing modules. It should be readily understood that the computing environment depicted in FIG. 2 is an example of a possible implementation according to the present disclosure, and thus, it should not be considered limiting or exclusive.

The vehicle 202 may further include the car wash management unit 212, as described above. The car wash management unit 212 may include one or more components including, but not limited to, a transceiver 240, a processor 242, and a memory 244, which may be communicatively coupled with each other. In some aspects, the processor 242 and the memory 244 may be same as or similar to the processor 216 and the memory 218.

The processor 242 may be an Artificial Intelligence (AI) based processor and may be disposed in communication with one or more memory devices, e.g., the memory 244 and/or one or more external databases (not shown in FIG. 2). The processor 242 may utilize the memory 244 to store programs in code and/or to store data for performing various unit operations in accordance with the present disclosure. The memory 244 may be a non-transitory computer-readable medium or memory storing the car wash management program code. The memory 244 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In some aspects, the memory 244 may store computer-executable instructions, and the processor 242 may be configured and/or programmed to execute the stored computer-executable instructions for performing unit functions in accordance with the present disclosure. Specifically, the memory 244 may store computer-executable instructions associated with one or more supervised or unsupervised machine learning algorithms that may enable the processor 242 to perform the unit functions. Examples of machine learning algorithms include, but are not limited to, algorithms associated with Linear Classifiers (Logistic Regression, Naive Bayes Classifier), Nearest Neighbor, Support Vector Machines, Decision Trees, Boosted Trees, Random Forest, hidden Markov Model, and/or Neural Networks.

In operation, the processor 242 may obtain inputs from the first detection unit via the transceiver 240. In some aspects, the processor 242 may obtain the inputs from the first detection unit when the processor 242 determines that a predetermined condition may be met. For example, the processor 242 may obtain the inputs from the first detection unit when the processor 242 determines that the vehicle 202 may be in vicinity of/proximity to the car wash station 104 (e.g., by using GPS navigation/signals obtained from the NAV receiver 234). In addition or alternatively, the processor 242 may obtain the inputs from the first detection unit when the vehicle speed may be less than a predetermined threshold (e.g., less than 25 mph), determined based on inputs obtained from the VCU 210.

Responsive to obtaining the inputs from the first detection unit, the processor 242 may determine that the vehicle 202 may be approaching or heading towards the car wash station 104. In some aspects, the processor 242 may determine that the vehicle 202 may be disposed within a predetermined distance from the car wash entry point 108 based on the inputs obtained from the first detection unit. In an exemplary aspect, the processor 242 may use the images obtained from the first detection unit/vehicle cameras (such as a forward-windshield camera (FWC) 302, shown in FIG. 3) and Artificial Intelligence (AI)/Machine learning (ML) algorithms (shown as AI/ML algorithm 304 in FIG. 3) stored in the memory 244 to determine that the vehicle 202 may be approaching/entering the car wash station 104 via the car wash entry point 108 (as shown in block 306 of FIG. 3). For example, the processor 242 may use the AI/ML algorithm 304 and compare the obtained images with pre-stored images associated with the car wash station (that may be stored in the memory 244) to determine that the vehicle 202 may be approaching the car wash station 104. In addition, the processor 242 may obtain the information associated with the car wash station map/architecture from the server 204 (via the transceiver 240) and may then determine that the vehicle 202 may be disposed/located within the predetermined distance from the car wash entry point 108.

Responsive to a determination that the vehicle 202 may be approaching the car wash entry point 108 and/or the vehicle 202 may be disposed/located within the predetermined distance from the car wash entry point 108, the processor 242 may perform a predetermined action (e.g., a first predefined action). In some aspects, the predetermined action may include disabling/turning-off automatic operation of vehicle wipers (as shown in block 308). For example, the processor 242 may transmit instructions to the BCM 220 to turn-off the vehicle wipers when the vehicle may be in the stage A (as described above in conjunction with FIG. 1). The processor 242 may further output/transmit (e.g., via the transceiver 240) a notification to the vehicle user via the infotainment system 238 responsive to disabling the vehicle wiper operation (as shown in block 310 of FIG. 3). An example notification 402 notifying the vehicle user that the vehicle wipers are deactivated/disabled is depicted in FIG. 4. In another aspect, the predetermined action may include transmitting a notification to the vehicle user, via the infotainment system 238, requesting the vehicle user to manually turn-off the vehicle wipers when the processor 242 determines that the vehicle 202 may be in the stage A. The vehicle user may view/hear the notification and may accordingly turn-off the vehicle wipers.

In the similar manner, the processor 242 may automatically fold the side-view mirrors and close the vehicle windows when the processor 242 determines that the vehicle 202 may be in the stage A (i.e., when the vehicle 202 may be approaching the car wash entry point 108 and/or disposed or located within the predetermined distance from the car wash entry point 108). In this case, the processor 242 may transmit an instruction to the BCM 220 to fold the mirrors and close the windows, when the vehicle 202 may be in the stage A. Alternatively, the vehicle 202 may transmit an instruction to the vehicle user, via the infotainment system 238, to manually fold the side-view mirrors and close the vehicle windows, when the vehicle 202 may be in the stage A.

In further aspects, the processor 242 may obtain the inputs from the first detection unit and/or the second detection unit and may estimate a distance between the vehicle 202 and the track 106 based on the obtained inputs. For example, the processor 242 may obtain inputs from an ultrasonic sensor 312a and a radar sensor 312b (that may be part of the second detection unit) and a front bumper camera (FBC) 312c (that may be part of the first detection unit) and may estimate the distance between the vehicle 202 and the track 106 based on the inputs. Responsive to estimating the distance, the processor 242 may determine the vehicle position relative to the track 106 based on the estimated distance and may determine whether the vehicle 202 may have entered the stage B (on be in the car wash station 104) based on the vehicle position.

In some aspects, the processor 242 may use positional feature set (shown in block 314), stereo camera distance algorithm (shown in block 316), and the AI/ML algorithm 304 to determine the vehicle position (or alignment) relative to the track 106 (as shown in block 318). The processor 242 may be configured to perform a predetermined action (e.g., a second predefined action) responsive to a determination that the vehicle 102 may have entered the stage B (based on the vehicle position relative to the track 106). In some aspects, the second predefined action may include automatically moving and aligning the vehicle 202 (e.g., a vehicle wheel, as shown in block 320) with the track 106, such as via DAT controller 228, when the vehicle 202 may have entered the stage B. For example, the processor 242 may transmit an instruction/command signal to the ECU 214 to move the vehicle 202 such that the vehicle 202 may get aligned with the track 106. In some aspects, the processor 242 may alternatively transmit a notification/instruction, via the infotainment system 238, to the vehicle user to manually align the vehicle 202 with the track 106.

Responsive to transmitting the command signal to the ECU 214 or the notification to the vehicle user (via the infotainment system 238), the processor 242 may determine whether the vehicle 202 may be aligned with the track 106 based on the inputs obtained from the first detection unit and/or the second detection unit. Responsive to a determination that the vehicle 202 may not be aligned with the track 106, the processor 242 may transmit instructions/feedback to the ECU 214 or the vehicle user via the infotainment system 238 to properly align the vehicle 202 with the track 106 and position the vehicle 202 on the track 106.

In some aspects, the processor 242 may perform a predetermined action (e.g., a third predefined action) when the vehicle 202 may be aligned/positioned on the track 106. The third predetermined action may include transmitting an instruction to the ECU 214 to automatically position the vehicle 202 in the neutral mode, as shown in block 322. Stated another way, the processor 242 may position the vehicle 202 in the neutral mode when the vehicle 202 may be positioned on the track 106 (so that the track 106 may conveniently pull the vehicle 202 through the plurality of zones in the car wash station 104). The processor 242 may further transmit a notification to the vehicle user via the infotainment system 238 indicating that the vehicle 202 is placed in the neutral mode, as shown in block 324. Alternatively, the processor 242 may transmit an instruction/notification to the vehicle user via the infotainment system 238 requesting the vehicle user to manually place the vehicle 202 in the neutral mode, when the processor 242 determines that the vehicle 202 may be positioned/aligned on the track 106.

In additional aspects, the processor 242 may obtain inputs from other sensory systems, such as a vehicle interior camera 326 and a side view camera (SVC) 328 (and other camera units) and may use sign detection AI/ML algorithm (shown in block 330) to perform one or more of the operations described above. For example, the processor 242 may obtain images from the cameras described above and may perform gesture recognition on the obtained images to control vehicle operation/movement such as aligning vehicle 202 with the track 106, putting the vehicle 202 in the neutral mode, and/or the like, based on the gesture recognition.

In further aspects, the processor 242 may determine that the vehicle 202 may be exiting the car wash station 104 (e.g., after getting washed/cleaned) based on the inputs obtained from the first detection unit and/or the second detection unit. For example, the processor 242 may obtain inputs from a rear view camera (RVC) 332 and may use the AI/ML algorithm 304 to determine that the vehicle 202 may exiting the car wash station 104 (as shown in block 334). In some aspects, the processor 242 may use the AI/ML algorithm 304 and compare the images obtained from the RVC 332 with pre-stored images associated with the car wash station 104 (stored in the memory 244) to determine that the vehicle 202 may be exiting the car wash station 104. In addition, the processor 242 may use the information associated with the car wash station map/architecture (that the processor 242 may obtain from the server 204) and the obtained images to determine that the vehicle 202 may be exiting the car wash exit point 110 (or may be in the stage C).

Responsive to a determination that the vehicle 202 may be exiting the car wash station 104, the processor 242 may perform another predetermined action (e.g., a fourth predefined action). In some aspects, the fourth predetermined action may be reverse of the first predetermined direction. For example, the fourth predetermined action may include re-enabling the vehicle wipers or turning ON the vehicle wipers when the vehicle 202 may be in the stage C (as shown in block 338). In some aspects, the processor 242 may turn-on the automatic operation of the vehicle wipers after a predefined delay (shown as block 336). The predefined delay may be a time-based delay or a distance-based delay. For example, the processor 242 may turn-on the vehicle wipers after a predetermined time duration (e.g., 10-30 seconds) of the vehicle 202 exiting the car wash station 104. In another aspect, the processor 242 may turn-on the vehicle wipers when the vehicle 102 may be disposed a predetermined distance (e.g., 10-20 meters) away from the car wash exit point 110 after exiting the car wash station 104. The processor 242 may further transmit a notification to the vehicle user via the infotainment system 238 indicating that the automatic operation of the vehicle wipers is enabled. In yet another aspect, the processor 242 may transmit an instruction to the vehicle user (via the infotainment system 238) requesting the vehicle user to manually turn-on the automatic operation of the vehicle wipers. In the similar manner, the processor 242 may position the vehicle 202 out of the neutral mode, unfold the side view mirrors, etc., when the processor 242 determines that the vehicle 202 may have exited the car wash station 104.

In further aspects, the processor 242 may be configured to determine one or more actions to be performed responsive to a determination that the vehicle 202 may be approaching the car wash entry point 108 and/or the vehicle 202 may be disposed/located within the predetermined/predefined distance from the car wash entry point 108. The actions may include automatic disabling/turning-off automatic operation of vehicle wipers, folding the side-view mirrors and closing the vehicle windows, aligning the vehicle 202 relative to the track 106, positioning the vehicle in the neutral mode, etc., responsive to the determination of the actions. Alternatively, the actions may include outputting notifications/instructions to the vehicle user requesting the vehicle to manually perform the actions described above, responsive to the determination of the actions.

In some aspects, the processor 242 may determine a first action when the vehicle 202 may be approaching the car wash entry point 108. The first action may include one or more steps (such as a first step and a second step). For example, the first action may include positioning the vehicle in the neutral mode, and one or more steps associated with the first action may include pressing and holding the vehicle speed reduction pedal, shifting the vehicle in neutral, pressing low button on a dial such as rotary dial, releasing the vehicle speed reduction pedal, turning-off the vehicle, deactivating stop-start functionality, and/or the like. In some aspects, the processor 242 may output a first notification to the vehicle user requesting the vehicle user to perform the first step (e.g., press and hold the vehicle speed reduction pedal). Further, the processor 242 may determine that the first step may be completed responsive to outputting the first notification. For example, the processor 242 may obtain inputs from the VCU 210 and determine that the vehicle user may have completed the first step. Responsive to a determination that the first step may be completed, the processor 242 may output a second notification to the vehicle user requesting the vehicle user to perform the second step (e.g., shift the vehicle in neutral, press low button, and/or release the vehicle speed reduction pedal). Further, the processor 242 may determine that the second step may be completed responsive to outputting the second notification (e.g., based on the inputs obtained from the VCU 210). The processor 242 may output a third notification indicating that the first action may be completed based on the determination that the first step and the second step may be completed.

In further aspects, the processor 242 may be configured to determine a second action when the vehicle 202 may be approaching the car wash entry point 108. The processor 242 may determine the second action along with the first action or sequentially in any order. The second action may include disabling vehicle wipers, folding side view mirrors, closing windows, and/or the like. In some aspects, the processor 242 may output a fourth notification to the vehicle user requesting the vehicle user to manually disable operation of vehicle wipers (or fold side view mirrors, close windows, etc.) when the vehicle 202 may be approaching the car wash entry point 108. The processor 242 may further output a fifth notification confirming that the operation of the vehicle wipers may be disabled, when the vehicle user disables the operation of the vehicle wipers.

In further aspects, the processor 242 may be configured to determine a third action when the vehicle 202 may be approaching the car wash entry point 108. The third action may include aligning the vehicle 202 relative to the track 106. In some aspects, the processor 242 may obtain inputs from the second detection unit and may estimate the distance between the vehicle 202 and the track 106 based on the inputs. Based on the estimation of the distance, the processor 242 may output a sixth notification to the vehicle user requesting the vehicle user to manually align the vehicle 202 relative to the track 106. The processor 242 may further determine that the vehicle 202 may be aligned responsive to outputting the sixth notification. In some aspects, the processor 242 may determine that the vehicle 202 may be aligned relative to the track 106 based on the inputs obtained from the second detection unit. Responsive to a determination that the vehicle 202 may be aligned, the processor 242 may output the first notification as described above (e.g., to initiate the steps to position the vehicle 202 in the neutral mode).

In further aspects, the processor 242 may be configured to determine a fourth action to be performed when the vehicle 202 may be exiting the car wash exit point 110. The processor 242 may output a seventh notification requesting the vehicle user to perform the fourth action responsive to a determination of the fourth action. The fourth action may include, for example, re-enabling vehicle wipers and/or positioning the vehicle out of the neutral mode. In some aspects, the processor 242 may be configured to output the seventh notification after a predetermined time duration of the vehicle 202 exiting the car wash station 104. In further aspects, the processor 242 may be configured to output the seventh notification when the vehicle 202 may be a predetermined distance away from the car wash exit point 110 after exiting the car wash station 104.

In further aspects, the processor 242 may be configured to perform the first action, the second action, the third action and the fourth action automatically responsive to the determination of respective actions. The processor 242 may perform the first action, the second action, and the third action simultaneously or sequentially in any order.

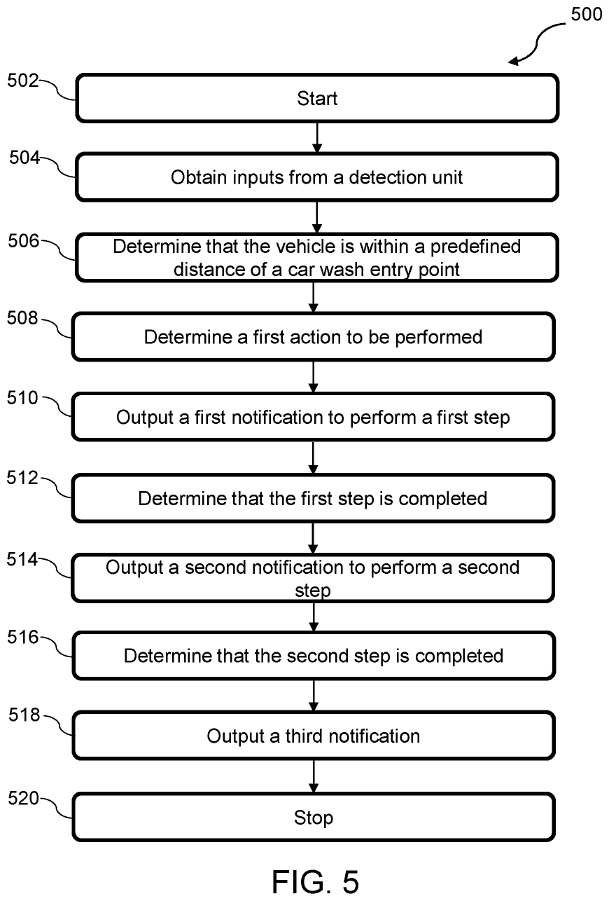

FIG. 5 depicts a flow diagram of an example method 500 for controlling operation of the vehicle 202 in the car wash station 104 in accordance with the present disclosure. FIG. 5 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 500 starts at step 502. At step 504, the method 500 may include obtaining, by the processor 242, inputs from a detection unit (e.g., the first detection unit and/or the second detection unit).

At step 506, the method 500 may include determining, by the processor 242, that the vehicle 202 may be within a predefined distance from the car wash entry point 108 based on the obtained inputs. Stated another way, the processor 242 may determine that the vehicle 202 may be approaching the car wash station 104 based on the obtained inputs.

At step 508, the method 500 may include determining, by the processor 242, a first action to be performed when the vehicle 202 may be within the predefined distance from the car wash entry point 108. The first action may include one or more steps (including the first step and the second step described above) that may be performed sequentially by the vehicle user. In some aspects, the first action may include positioning the vehicle 202 in the neutral mode, and one or more steps may include pressing and holding vehicle speed reduction pedal, shifting the vehicle 202 in neutral, pressing low button, releasing the vehicle speed reduction pedal, turning-off the vehicle 202, deactivating stop-start functionality, etc.

At step 510, the method 500 may include outputting, by the processor 242, the first notification requesting the vehicle user to perform the first step. At step 512, the method 500 may include determining, by the processor 242, that the first step may be completed. At step 514, the method 500 may include outputting, by the processor 242, the second notification requesting the vehicle user to perform the second step responsive to a determination that the first step may be completed. At step 516, the method 500 may include determining, by the processor 242, that the second step may be completed. At step 518, the method 500 may include outputting, by the processor 242, the third notification indicating that the first action may be completed based on the determination that the first step and the second step may be completed. At step 520, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a first detection unit configured to capture images outside the vehicle;
a processor communicatively coupled to the first detection unit, wherein the processor is configured to:
obtain inputs from the first detection unit;
determine that the vehicle is within a predefined distance of a car wash station entry point associated with a car wash station based on the inputs;
determine a first action to be performed when the vehicle is within the predefined distance, wherein the first action comprises one or more steps;
output a first notification to perform a first step of the one or more steps;
determine that the first step is completed;
output a second notification to perform a second step of the one or more steps responsive to a determination that the first step is completed;
determine that the second step is completed; and
output a third notification indicating that the first action is completed based on the determination that the first step and the second step are completed.

2. The vehicle of claim 1, wherein the first action comprises positioning the vehicle in a neutral mode.

3. The vehicle of claim 1, wherein the one or more steps comprises press and hold vehicle speed reduction pedal, shift the vehicle in neutral, press low button, release the vehicle speed reduction pedal, turn-off the vehicle, and deactivate stop-start functionality.

4. The vehicle of claim 1, wherein the processor is further configured to determine a second action to be performed when the vehicle is within the predefined distance, wherein the second action comprises disabling vehicle wipers.

5. The vehicle of claim 4, wherein the processor is further configured to output a fourth notification to disable operation of vehicle wipers when the vehicle is within the predefined distance.

6. The vehicle of claim 1 further comprising a second detection unit configured to detect a position of the vehicle relative to a track associated with the car wash station.

7. The vehicle of claim 6, wherein the processor is further configured to:
obtain inputs from the second detection unit; and
estimate a distance between the vehicle and the track based on the inputs from the second detection unit.

8. The vehicle of claim 7, wherein the processor is further configured to output a fifth notification to align the vehicle on the track based on the estimation of the distance.

9. The vehicle of claim 8, wherein the processor is further configured to determine that the vehicle is aligned with the track based on the inputs from the second detection unit.

10. The vehicle of claim 9, wherein the processor is configured to output the first notification responsive to a determination that the vehicle is aligned with the track.

11. The vehicle of claim 1, wherein the processor is further configured to:
determine that the vehicle is exiting the car wash station based on the inputs from the first detection unit;
determine a third action to be performed based on a determination that the vehicle is exiting the car wash station; and
output a sixth notification to perform the third action responsive to a determination of the third action.

12. The vehicle of claim 11, wherein the processor is configured to output the sixth notification after a predetermined time duration of the vehicle exiting the car wash station.

13. The vehicle of claim 11, wherein the processor is further configured to output the sixth notification when the vehicle is at a predetermined distance away from a car wash exit point after exiting the car wash station.

14. The vehicle of claim 11, wherein the third action comprises re-enabling vehicle wipers and/or positioning the vehicle out of a neutral mode.

15. The vehicle of claim 1, wherein the processor is further configured to:
compare the images with pre-stored images associated with the car wash station; and
determine, based on comparing the images with pre-stored images associated with the car wash station, that the vehicle is within the predefined distance of the car wash station entry point.

16. A method comprising:
obtaining, by a processor, inputs from a detection unit, wherein the detection unit is configured to capture images outside a vehicle;
determining, by the processor, that the vehicle is within a predefined distance of a car wash station entry point associated with a car wash station based on the inputs;
determining, by the processor, a first action to be performed when the vehicle is within the predefined distance, wherein the first action comprises one or more steps;
outputting, by the processor, a first notification to perform a first step of the one or more steps;
determining, by the processor, that the first step is completed;
outputting, by the processor, a second notification to perform a second step of the one or more steps responsive to a determination that the first step is completed;
determining, by the processor, that the second step is completed; and
outputting, by the processor, a third notification indicating that the first action is completed based on the determination that the first step and the second step are completed.

17. The method of claim 16, wherein the first action comprises positioning the vehicle in a neutral mode.

18. The method of claim 16, wherein the one or more steps comprises press and hold vehicle speed reduction pedal, shift the vehicle in neutral, press low button, release the vehicle speed reduction pedal, turn-off the vehicle, and deactivate stop-start functionality.

19. The method of claim 16 further comprising determining a second action to be performed when the vehicle is within the predefined distance, wherein the second action comprises disabling vehicle wipers.

20. A non-transitory computer-readable storage medium having instructions stored thereupon which, when executed by a processor, cause the processor to:
obtain inputs from a detection unit, wherein the detection unit is configured to capture images outside a vehicle;
determine that the vehicle is within a predefined distance of a car wash station entry point associated with a car wash station based on the inputs;
determine a first action to be performed when the vehicle is within the predefined distance, wherein the first action comprises one or more steps;
output a first notification to perform a first step of the one or more steps;
determine that the first step is completed;
output a second notification to perform a second step of the one or more steps responsive to a determination that the first step is completed;
determine that the second step is completed; and
output a third notification indicating that the first action is completed based on the determination that the first step and the second step are completed.
